(19) United States
(12) Patent Application Publication
(10) Pub. No.: US 2007/0116429 A1
(43) Pub. Date: May 24, 2007

(54) Broadcast recording apparatus and broadcast recording method

(75) Inventors: Masaki Tsuchida, Ome-shi (JP); Noriya Sakamoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/606,024

(22) Filed: Nov. 30, 2006

(30) Foreign Application Priority Data
Nov. 20, 2005 (JP) 2005-346089

(51) Int. Cl. H04N 5/91

(52) U.S. Cl. 386/83

(57) ABSTRACT

According to one embodiment, a broadcast recording apparatus has a tuner unit which receives a broadcast signal, demodulates the received signal, and outputs video image and voice signals, first and second hard disk drive units which record the video image and voice signals from the tuner unit in a memory region, and a control unit which controls the first and second hard disk drive units to record the video image and voice signals in each one of a first storage memory region of the first hard disk drive unit and a second storage memory region of the second hard disk drive unit.

### CROSS-REFERENCE TO RELATED APPLICATIONS

This application is based upon and claims the benefit of priority from Japanese Patent Application No. 2005-346089, filed Nov. 30, 2005, the entire contents of which are incorporated herein by reference.

### BACKGROUND

1. Field

One embodiment of the invention relates to a broadcast recording apparatus for recording a video image signal in a plurality of hard disk drive units, and particularly to a broadcast recording apparatus for recording identical video image and voice signals in a plurality of hard disk drive units.

2. Description of the Related Art

Recently, with prevalence of a digital device, a broadcast receiving apparatus such as a hard disk recorder has been generally known. A plenty of video image information can be recorded and reproduced more easily than a case of a recording and reproducing processing operation by a conventional video tape recorder (VTR). In such a broadcast receiving apparatus, reservation image recording or the like can be carried out by simple operation so that a plenty of video image and voice information is recorded in a storage region. Therefore, a variety of hard disk image recording methods become effective according to a user's program viewing mode as well as merely recording video image and voice signals in one hard disk.

In patent document 1 (Jpn. Pat. Appln. KOKAI Publication No. 2003-61022), there is disclosed a broadcast program recording apparatus in which a plurality of hard disk drives are provided, one hard disk drive is used for overwrite recording of program contents that are repeating image recording within a predetermined time interval, and the other hard disk drive is used for storage image recording for storing the overwritten and recorded program contents for a long period of time.

However, in the above-described conventional technique, only one hard disk drive is used for storing program contents for a long period of time. In this hard disk drive, there is a case in which reproduction is suddenly disabled due to degradation with an elapse of time, a data error and the like. In this case, a hard disk drive capability is often recovered by formatting the drive. However, there is a problem that recorded program contents cannot be reproduced once the drive is formatted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of a broadcast recording apparatus according to an embodiment of the present invention;

FIG. 2 is an illustrative view showing an example of a recording storage system which the broadcast recording apparatus has;

FIG. 3 is an illustrative view showing an example of the recording storage system which the broadcast recording apparatus has;

FIG. 4 is an illustrative view showing an example of the recording storage system which the broadcast recording apparatus has;

FIG. 5 is an illustrative view showing an example of the recording storage system which the broadcast recording apparatus has;

FIG. 6 is an illustrative view showing an example of the recording storage system which the broadcast recording apparatus has;

FIG. 7 is an illustrative view showing an example of the recording storage system which the broadcast recording apparatus has;

FIG. 8 is an illustrative view showing an example of the recording storage system which the broadcast recording apparatus has;

FIG. 9 is an illustrative view showing an example of the recording storage system which the broadcast recording apparatus has;

FIG. 10 is an illustrative view showing an example of the recording storage system which the broadcast recording apparatus has;

FIG. 11 is an illustrative view showing an example of a remote control device for operating the broadcast recording apparatus;

FIG. 12 is a flow chart showing an example of a storage processing operation of the broadcast recording apparatus; and

FIG. 13 is a flow chart showing an example of a storage processing operation including mirror storage of the broadcast recording apparatus.

### DETAILED DESCRIPTION

Various embodiments according to the invention will be described hereinafter with reference to the accompanying drawings. In general, according to one embodiment of the invention, it is an object thereof to provide a broadcast recording apparatus capable of improving fault tolerance and capable of recording broadcast contents in a reliably reproducible manner.

According to an embodiment of the present invention, there is provided a broadcast recording apparatus comprising: a tuner unit which receives a broadcast signal, demodulates the received signal, and outputs video image and voice signals; first and second hard disk drive units which record the video image and voice signals in a storage region; and a control unit which controls the first and second hard disk drive units to record the video image and voice signals in each one of a first storage memory region of the first hard disk drive unit and a second storage memory region of the second hard disk drive unit.

In this broadcast recording apparatus, identical broadcast contents are subjected to mirror image recording in a plurality of hard disk drives, respectively. Thus, even if one of the hard disk drives is unfortunately disabled for reproduction, the broadcast contents recorded as images in the other hard disk can be reproduced.

There is provided a broadcast recording apparatus capable of recording broadcast contents in a reliably reproducible manner by improving fault tolerance.

Now, embodiments of the present invention will be described in detail with reference to the accompanying drawings.

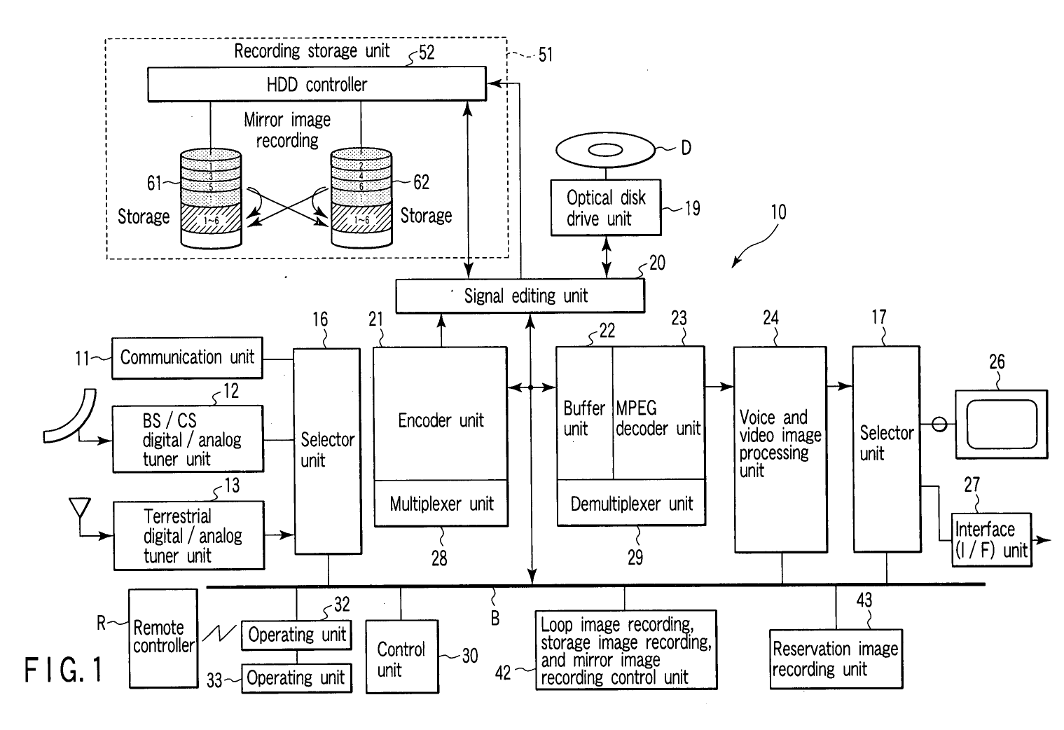

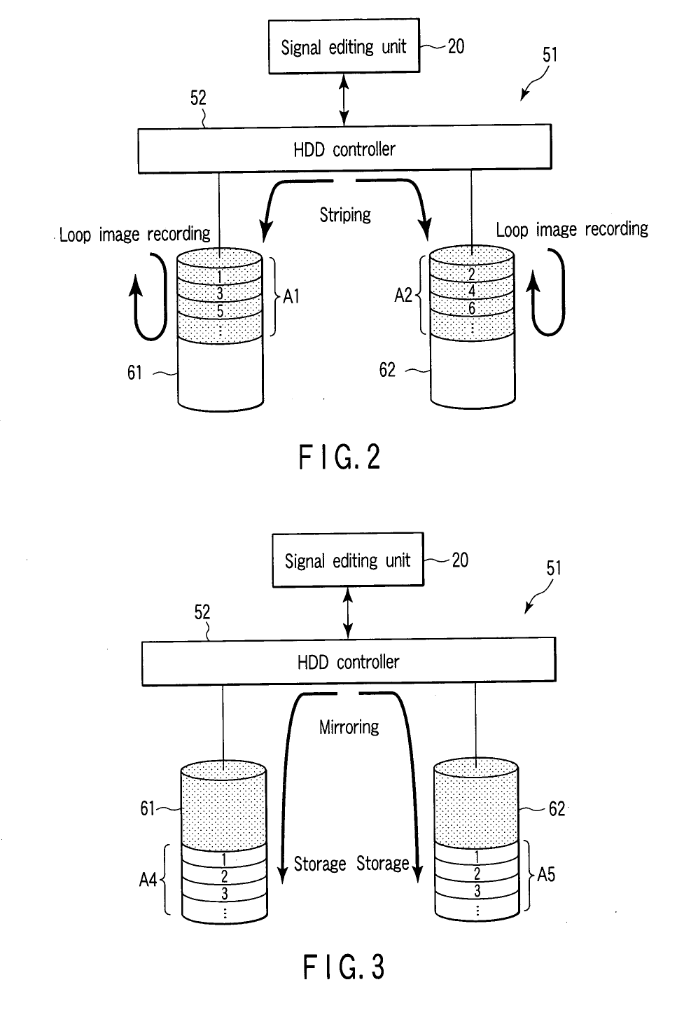

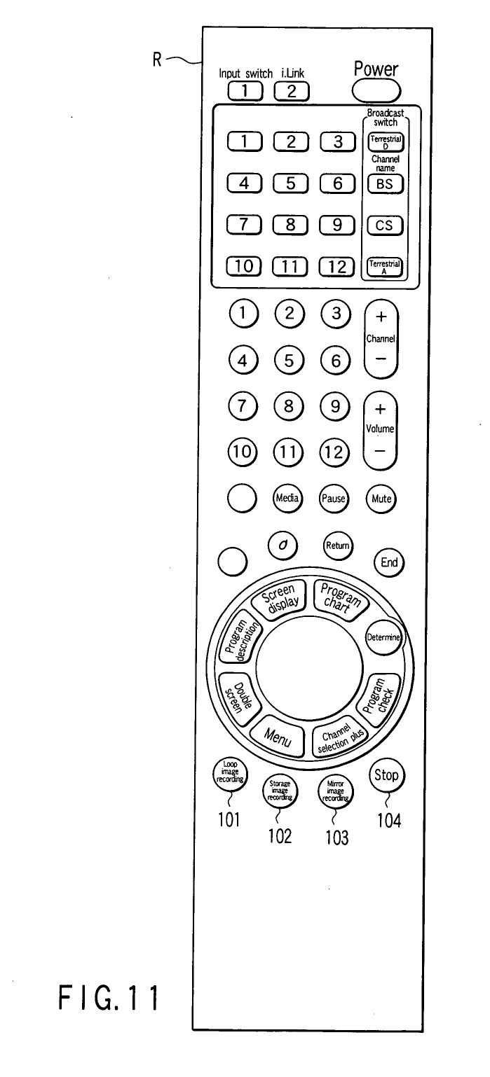

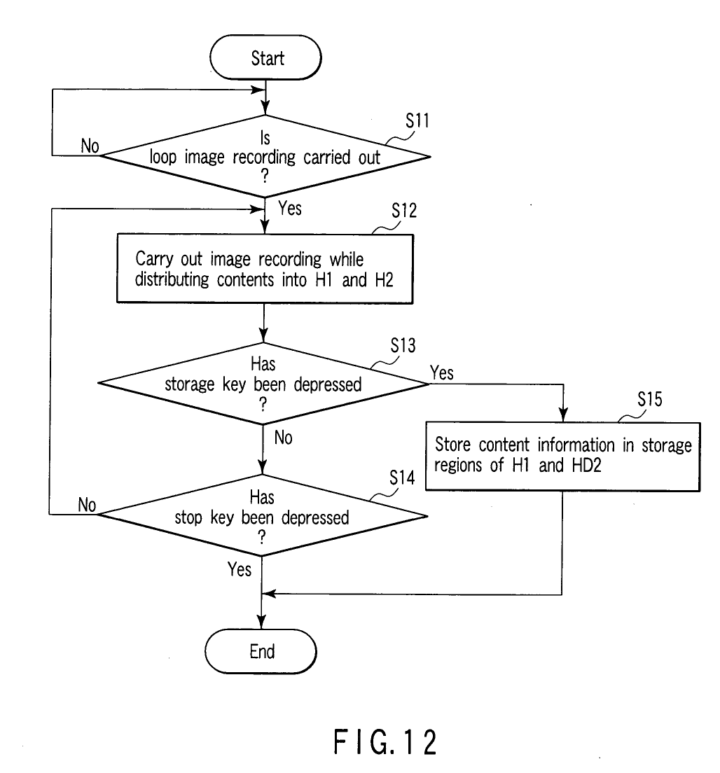

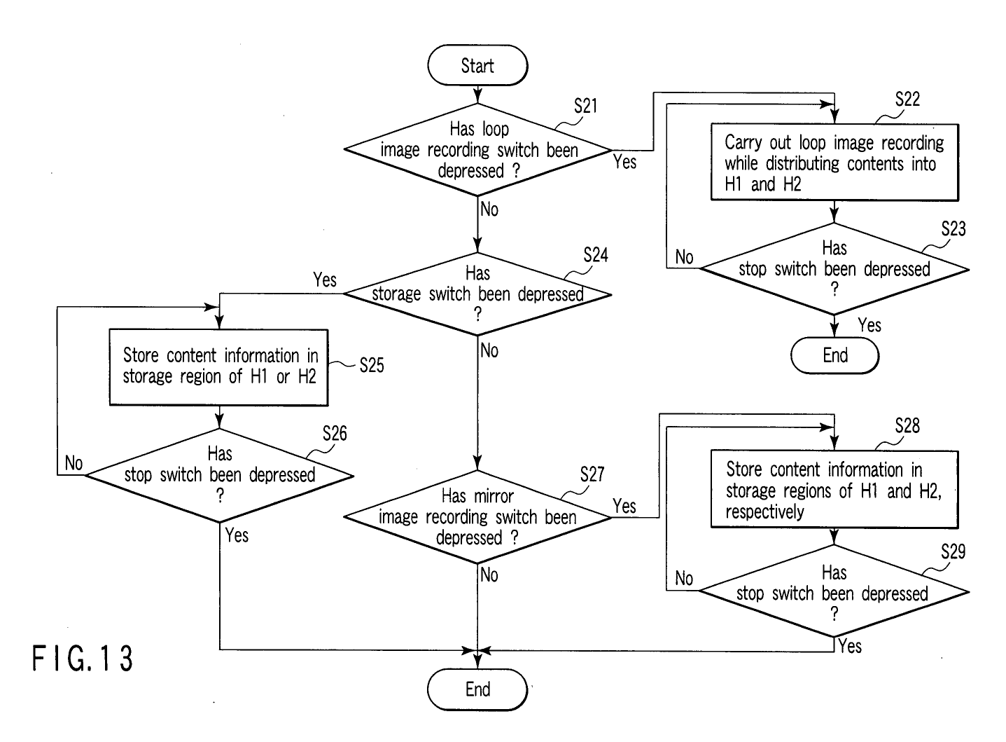

That is, FIG. 1 is a block diagram depicting an example of a configuration of a broadcast recording apparatus according to an embodiment of the present invention; FIGS. 2 to 10 are illustrative views each showing an example of a configuration of a recording storage system which the broadcast recording apparatus has; FIG. 11 is an illustrative view showing an example of a remote control device for operating the broadcast recording apparatus; FIG. 12 is a flow chart showing an example of a storage processing operation of the broadcast recording apparatus; and FIG. 13 is a flow chart showing an example of a storage processing operation including mirror storage of the broadcast recording apparatus.

<Broadcast Recording Apparatus According to an Embodiment of the Present Invention>

(Configuration)

First, a broadcast recording apparatus 10 shown in FIG. 1 is provided as an example of a digital television having a recording function while a tuner or the like is used as a source. However, a hard disk recorder having a tuner or the like and a recording function is also preferred similarly.

Therefore, while the following embodiments with reference to FIG. 1 will describe in detail a digital television having a recording function, it is possible to construe the embodiments as an explanation of a hard disk recorder having completely identical capabilities by separating a display 26 from the constituent elements shown in FIG. 1.

In FIG. 1, the broadcast recording apparatus 10 serving as a digital television has two types of disk drives. First, this apparatus has a recording storage unit 51 for driving a plurality of hard disks as a first medium. Secondly, this apparatus has an optical disk drive unit 19 for rotationally driving an optical disk D as a second medium that is an information recording medium capable of constructing a video file, and then, executing information read and write operations. In addition, a control unit 30 is connected to each unit via a data bus B to control a whole operation. However, in the case of carrying out the present invention, the optical disk drive unit 19 is not always a required constituent element.

In addition, the broadcast recording apparatus 10 shown in FIG. 1 primarily comprises: an encoder unit 21 that configures an image recording side; an MPEG decoder unit 23 that configures a reproduction side; and a control unit 30 that controls an operation of an apparatus main body. The broadcast recording apparatus 10 has an input side selector 16 and an output side selector 17. A communication unit 11 such as a LAN, a so called satellite broadcast (BS/CS) digital/analog tuner unit 12, and a so called terrestrial digital/analog tuner unit 13 are connected to the input side selector 16, thereby outputting a signal to the encoder unit 21. In addition, a satellite antenna is connected to the BS/CS digital/analog tuner unit 12 and a terrestrial antenna is connected to the terrestrial digital/analog tuner unit 13. In addition, the broadcast recording apparatus 10 has: an encoder unit 21; a signal editing unit 20 for receiving an output from the encoder unit 21, and then, carrying out desired data processing such as data editing; a recording storage unit 51 connected to the signal editing unit 20; and the optical disk drive unit 19. Further, the broadcast recording apparatus 10 has: a recording storage unit 51; an MPEG decoder unit 23 for receiving and decoding a signal from the optical disk drive unit 19; an encoder unit 21; a buffer unit 22; an MPEG decoder unit 23; a multiplexer unit 28; a demultiplexer unit 29; a control unit 30; a loop image recording/storage image recording/mirror image recording control unit 42; and a reservation image recording unit 43. These units each are connected to the control unit 30 via the data bus B. Further, an output from the selector unit 17 is supplied to a display 26 or is supplied to an external device via an interface unit 27 for making communication with the external device.

Further, the broadcast recording apparatus 10 has an operating unit 32 connected to the control unit 30 via the data bus B and receiving a user operation or an operation of a remote controller R. Here, the remote controller R enables operations that are substantially identical to those of the operating unit 32 provided at a main body of the broadcast recording apparatus 10. This remote controller enables a variety of settings such as supply of a recording or reproducing command for the recording storage unit 51 or the optical disk drive unit 19, supply of an edit command, a tuner operation, reservation image recording setting and the like.

(Basic Operation)

Reproduction of Broadcast Contents

In the broadcast recording apparatus 10 serving as the thus configured digital television, in accordance with an operating signal responsive to an operation of a user's remote controller R or the operating unit 32, a broadcast signal is received, and then, the broadcast contents from the BS/CS tuner unit 12 or the terrestrial digital/analog tuner unit 13 are displayed on the display 26, under the control of the control unit 30 or the like.

Recording Processing Operation

Now, an operation at the time of recording including those according to other embodiments will be described in detail. As an input side of the broadcast recording apparatus 10, a communication unit 11 such as a LAN is connected to an external device, thereby making communication with a program information providing server S or the like through a communication channel such as the Internet via a modem M or the like, or downloading contents and information or the like. In addition, the BS/CS digital/analog tuner unit 12 and the terrestrial digital/analog tuner unit 13 select a broadcast signal as a channel and demodulate it via an antenna, and input a video image signal and a voice signal. These tuner units cover diversified types of broadcast signals. For example, the tuner units cover a terrestrial analog broadcast, a terrestrial digital broadcast, a BS analog broadcast, a BS digital broadcast, a CS digital broadcast and the like without being limited thereto. In addition, there is not necessarily provided only one tuner unit. For example, two or three tuner units such as a terrestrial broadcast tuner unit and a BS/CS tuner unit may be provided to function in parallel to each other in response to a request for reservation image recording.

The previously described communication unit 11 may be an IEEE1394 interface and is capable of receiving digital contents from an external device over a network. In addition, it is also possible to receive a luminance signal, a color difference signal, a video image signal such as a composite signal, and a voice signal from an input terminal (not shown). These signals are selectively supplied to the encoder unit 21 by means of the selector 16 controlled by the control unit 30 or the like while inputs are controlled.

The encoder unit 21 has: a video use and an audio use analog/digital converter for digitizing an analog video signal or an analog audio signal inputted by means of the selector 16; a video encoder, and an audio encoder. For example, a subsidiary video image encoder is also included. An output from the encoder 21 is converted into a compression format such as predetermined MPEG, and the converted output is supplied to the previously described control unit 30.

In addition, the BS/CS analog/digital tuner 12 or the like is not always incorporated. Preferably, this tuner is externally provided via a data input terminal to supply the received digital signal to the encoder unit 21 or the control unit 30 via the selector unit 16.

Here, the apparatus shown in FIG. 1 supplies information (pack such as video, audio, and subsidiary video image data) encoded by the encoder unit 21 and produced management information to the recording storage unit 51 or the optical disk drive unit 19 via the control unit 30 so that the supplied items of information can be recorded in the recording storage unit 51 or the optical disk D. In addition, the information recorded in the recording storage unit 51 or the optical disk D can also be recorded in the optical disk D or the recording storage unit 51 via the control unit 30 or the optical disk drive unit 19.

The signal editing unit 20 is capable of making an edit processing operation such as partially deleting video objects of a plurality of programs recorded in the recording storage unit 51 or the optical disk D or connecting objects of different programs with each other.

Reproducing Processing Operation or the Like

Now a processing operation of reproducing recorded information including those according to other embodiments will mainly be described in detail. The MPEG decoder unit 23 comprises a video processor for properly combining a decoded subsidiary video image with a decoded main video image, and then, superimposing a menu, a highlight button, subtitles or any other subsidiary video image on a main video image to be outputted.

An output audio signal of the MPEG decoder unit 23 is supplied to a speaker after being analog-converted by means of a digital/analog converter (not shown), via the selector unit 17 or is supplied to an external device via the I/F 27. The selector unit 17 is controlled by a select signal from the control unit 30. In this manner, the selector unit 17 can directly select a signal having passed through the encoder unit 21 when a digital signal from each of the tuner units 12 and 13 is directly monitored.

Reservation Image Recording Processing Operation

In addition, based on electronic program information acquired from the communication unit 11 or the like, an image recording reservation processing operation can be made by means of the reservation image recording unit 43 in response to a program specified by an operation of a user's remote controller R or the like. Based on the reserved reservation image recording information and by working of the control unit 30 and the reservation image recording unit 43, when a reservation time has come, video image and voice signals produced when the program information received by the BS/CS digital/analog tuner unit 12 or the terrestrial digital/analog tuner unit 13 is demodulated is recorded (reserved and recorded as images) in the recording storage unit 51, for example, through an encode processing operation of the encoder 21 or the like.

The broadcast recording apparatus 10 according to the present embodiment has the thus comprehensive functions and carries out a recording/reproducing processing operation by an optical disk D or the recording storage unit 51 with respect to a plurality of sources.

<Recording Processing Operation Using a Plurality of Hard Disk Drives According to an Embodiment of the Present Invention>

Now, a recording processing operation using a recording storage unit 51 in the above-described broadcast recording apparatus 10 will be described in detail with reference to the accompanying drawings.

(Mode of Recording Storage Unit)

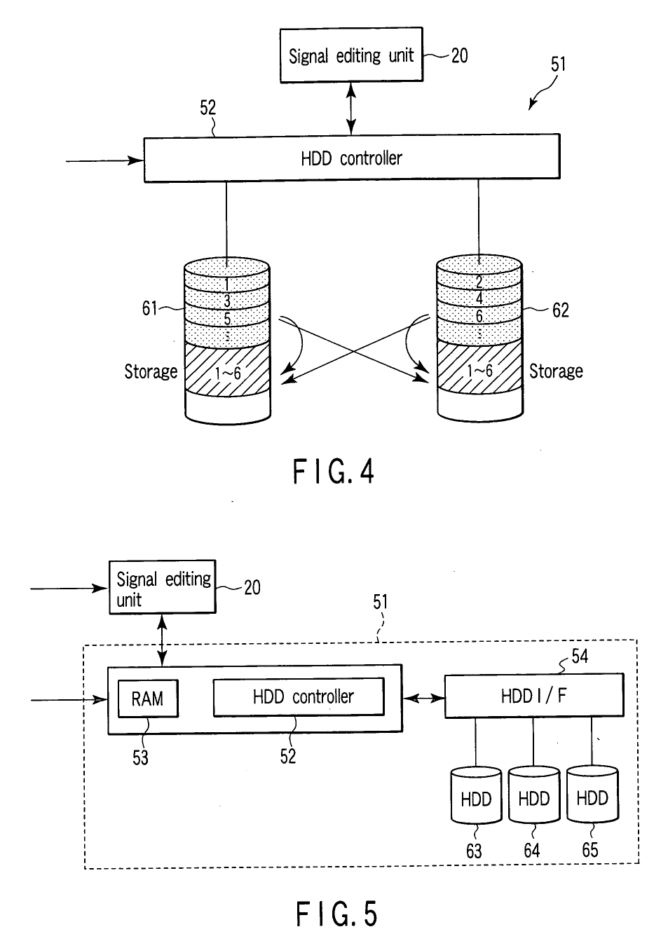

First, a specific mode of the recording storage unit 51 in the above-described broadcast recording apparatus 10 will be described with reference to the accompanying drawings. In FIG. 1, the recording storage unit 51 has: an HDD controller 52 controlled by means of a signal from a signal editing unit 20 and a signal from a data bus B; and a plurality of hard disk drives 61 and 62 controlled to be connected to the HDD controller 52. The recording storage unit 51 at least carries out loop image recording by striping, as shown in FIG. 2, carries out mirror image recording, as shown in FIG. 3, and carries out storage image recording of the loop-recorded image, as shown in FIG. 4.

These plurality of hard disk drives 61 and 62 and a hard disk drive described later are preferably configured in a removable manner. Two or more interfaces are prepared. SATA, ATA, IDE or the like are desirable without being limited thereto.

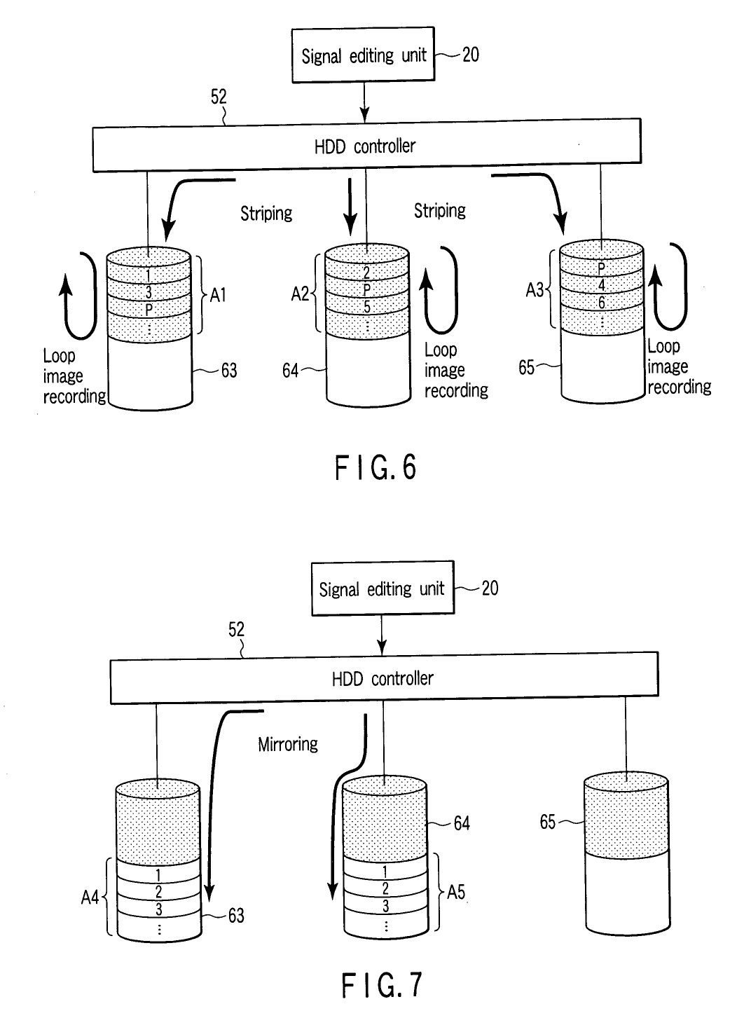

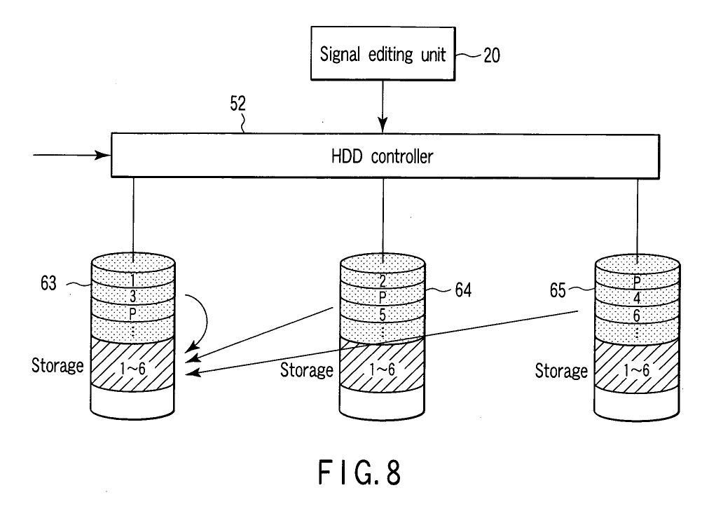

Further, as another mode of the recording storage unit 51, as shown in FIG. 5, three hard disk drives 63, 64, and 65 may be preferably provided via an HDD interface 54 connected to an HDD controller 52 and a RAM 53. The recording storage unit 51 carries out loop image recording by striping, as shown in FIG. 6, carries out mirror image recording, a shown in FIG. 7, and carries out storage image recording of a loop-recorded image, as shown in FIG. 8.

In the case where the three or more hard disk drives 63, 64, 65 or the like have been thus provided, it is effective to produce a parity, as shown in FIG. 8. That is, parity data of the data recorded in the first to third hard disk drives 63, 64, and 65 is produced by working of the HDD controller 52 or the like, and these items of data are recorded after divided into the first to third hard disk drives. Thus, even if a failure occurs with any one of the hard disk drives, data can be recovered. In addition, a parity may be produced even in the case where two hard disk drives are provided.

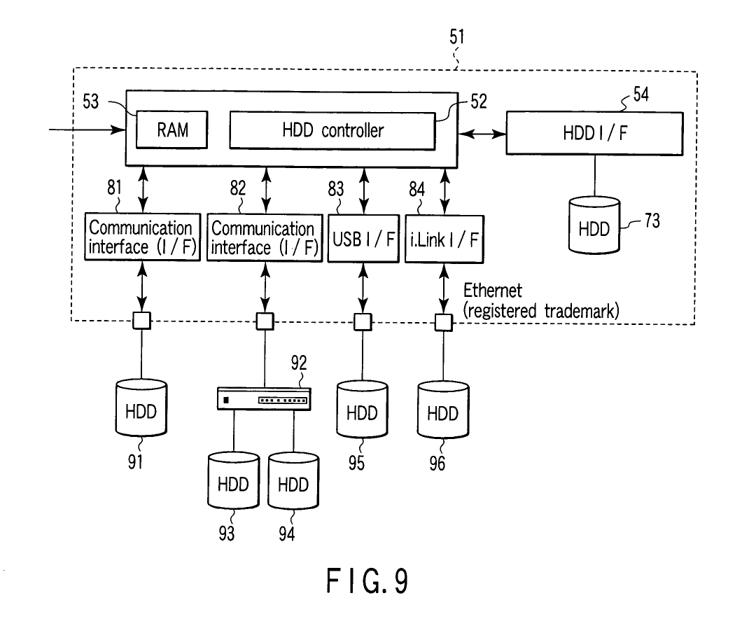

Further, as another mode of the recording storage unit 51, as shown in FIG. 9, one hard disk drive 73 is provided via the HDD interface 54 connected to the HDD controller 52 and the RAM 53. Further, a plurality of interfaces, i.e., communication interfaces (I/F) 81 and 82, a USB interface (I/F) 83, and an iLink interface (I/F) 84 are provided in this HDD controller 52. Here, an external HDD 91 is connected to the communication I/F 81; a plurality of HDDs 93 and 94 are connected to the communication I/F 82 via a hub 92; an HDD 95 is connected to the USB I/F 83; and an HDD 96 is connected to the iLink I/F 84.

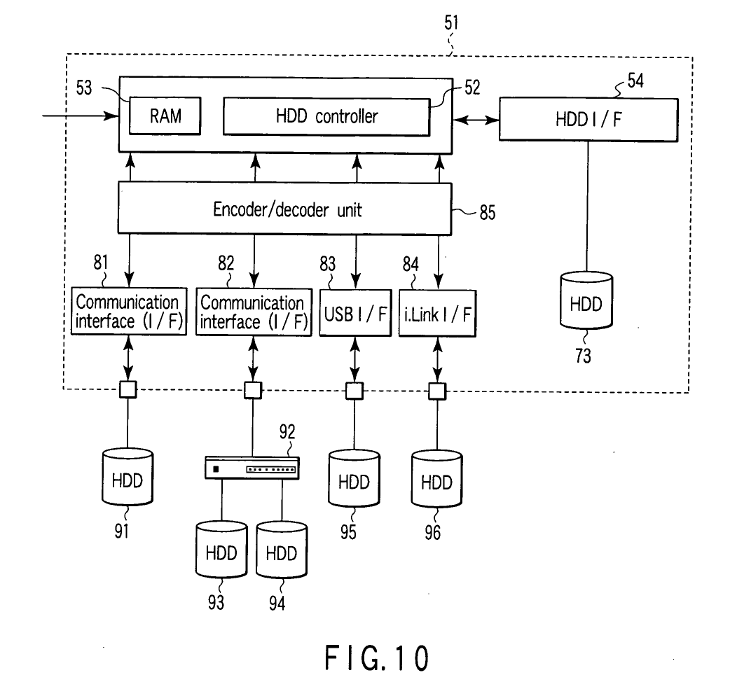

Further, in FIG. 10, in response to the mode of the recording storage unit 51 shown in FIG. 9, an encoder/decoder unit 85 is provided between the HDD controller and each of the interfaces. Thus, even if broadcast contents have been recorded in an external HDD, the broadcast contents can be prevented from externally leaking therefrom, thereby making it possible to protect a copyright of broadcast contents.

(Loop Image Recording and Storage Image Recording)

Now, loop image recording will be described with reference to a flow chart shown in FIG. 12 and with reference to FIGS. 2 and 6. In the broadcast recording/reproducing apparatus 10 according to an embodiment of the present invention, for example, in a state in which a reproduction video image produced when broadcast contents from the terrestrial digital/analog tuner unit 13 have been reproduced by means of a voice video image processing unit 24 is displayed on a display 26, loop image recording is carried out by a user depressing a loop image recording switch 101 of a remote controller (step S11).

That is, upon the receipt of an operating signal from the loop image recording switch 101, the control unit 30 and the loop image recording/storage image recording/mirror image recording control unit 42 supply video image and voice signals from the terrestrial digital/analog tuner unit 13 to an encoder unit 21, and the video image and voice signals encoded by the encoder unit 21 are supplied to the HDD controller 52 via the signal editing unit 20. Further, these video image and voice signals are stored after allocated (stripped) on a region by region basis in a loop storage region A1, A2, or A3 of each one of a plurality of HDDs 61 and 62 or HDDs 63, 64, and 65, as shown in FIGS. 2 and 6, by working of the loop image recording/storage image recording/mirror image recording control unit 42 and the HDD controller 52 (step S12). Here, loop image recording is carried out in a reproducible manner while a time limit such as two hours, for example, is provided. If an image recording time exceeds this time limit, loop memory regions A1 and A2 are further overwritten sequentially from the oldest regions. Thus, the overwritten region cannot be recorded, thereby making it possible to save a recording region of an HDD.

Further, when a remote controller's storage image recording switch 102 is depressed by a user (step S13), video image and voice signals stored in the loop memory regions A1, A2, and A3 are stored and memorized in storage memory regions A4 and A5 by working of the control unit 30 and the loop image recording/storage image recording/mirror image recording control unit 42. In this manner, there is no apprehension that video image and voice signals are deleted after overwritten as in a loop memory region, thus making it possible for a user to freely view a program at any time.

In addition, when a user depresses a stop switch 104 without depressing a remote controller's storage image recording switch 102 (step S14), loop image recording then terminates.

Here, as shown in FIG. 4, it is preferable to provide a plurality of HDDs as storage destinations and specify any of them on a content by content basis. It is preferable to specify this storage destination on a program by program basis in accordance with image recording reservation information on reservation image recording described later. In this manner, it becomes possible to reliably store a favorite program such as daily news or dramas.

(Mirror Image Recording)

Now, mirror image recording will be described with reference to a flow chart shown in FIG. 12 and with reference to FIGS. 2 and 6. By carrying out the above-described storage image recording, although video image and voice signals are recorded without being overwritten or deleted in a loop memory region, there is a case in which reproduction is suddenly disabled due to degradation with elapse of time or due to a data error depending on extended use of a hard disk. Here, a hard disk drive capability is often recovered by formatting the disk. However, program contents recorded after formatted cannot be reproduced.

In contrast, as shown in FIGS. 3 and 7, in mirror image recording, identical vide image and voice signals are recorded in a first storage memory region A4 of a first hard disk drive and a second storage memory region A5 of a second hard disk drive of each of a plurality of HDDs 61 and 62. Thus, even if one HDD is disabled for reproduction, disabled reproduction can be avoided by reproducing the video image and voice signals recorded in another HDD.

Loop Image Recording, Storage Image Recording, and Mirror Image Recording Using Remote Controller Switch

Now, loop image recording, storage image recording, and mirror image recording will be described in detail with reference to a flow chart shown in FIG. 13. It is preferable to control these loop image recording, storage image recording, and mirror image recording by means of switches 101, 102, 103, and 104 or the like of a remote controller R. That is, in the flow chart shown in FIG. 13, in a state in which a reproduction video image produced when broadcast contents from the terrestrial digital/analog tuner unit 13 have been reproduced by means of the voice and video image processing unit 24 is displayed on the display 26, for example, in response to the broadcast recording/reproducing apparatus 10 according to the present embodiment, loop image recording is carried out by a user depressing the loop image recording switch 101 of the remote controller (step S21).

At this time, the control unit 30 and the loop image recording/storage image recording/mirror image recording control unit 42 supply video image and voice signals from the terrestrial digital/analog tuner unit 13 to the encoder unit 21 upon the receipt of an operating signal from the loop image recording switch 101. The video image and voice signals encoded by means of the encoder unit 21 are supplied to the HDD controller 52 via the signal editing unit 20. Further, these video image and voice signals are stored after allocated (stripped) on a region by region basis in the loop memory region A1, A2, or A3 of each one of a plurality of HDDs 61 and 62 or HDDs 63, 64, and 65, as shown in FIGS. 2 and 6, by working of the loop image recording/storage image recording/mirror image recording control unit 42 and the HDD controller 52 (step S22). This loop image recording is stopped by depressing the stop switch 104 (step S23).

In addition, in a state in which a reproduction video image produced by reproducing broadcast contents by the voice and video image processing unit 24 is displayed on the display 26, when a user depresses the storage image recording switch 102 (S24) without depressing a remote controller's loop image recording switch 101 (step S21), video image and voice signals are supplied to the HDD controller 52 via the signal editing unit 20. Then, the resulting signals are stored in a storage memory region A4 of the HDD61 or a storage memory region A5 or the like of the HDD62, for example, as shown in FIGS. 3 and 7 by working of the loop image recording/storage image recording/mirror image recording control unit 42 and the HDD controller 52 (step S25). However, mirror image recording is not carried out. These storage image recordings are stopped by depressing the stop switch 104 (step S26).

Further, in a state in which a reproduction video image produced by reproducing broadcast contents by the voice and video image processing unit 24 is displayed on the display 26, when a user depresses a mirror image recording switch 103 (step S27) without depressing the remote controller's storage image recording switch 102 (step S24), the video image and voice signals are supplied to the HDD controller 52 via the signal editing unit 20. Then, mirror image recording is carried out by working of the loop image recording/storage image recording/mirror image recording control unit 42 and the HDD controller 52. That is, the video image and voice signals are supplied to the HDD controller 52 via the signal editing unit 20; and, for example, the identical video image and voice signals are recorded, respectively, in the storage memory region A4 of the HDD61 and the storage memory region A5 of the HDD62, as shown in FIGS. 3 and 7, by working of the loop image recording, storage image recording, and mirror image recording unit 42 and the HDD controller 52 (step 27). Thus, even if one HDD is disabled for reproduction, disabled reproduction can be avoided by reproducing the video image and voice signals recorded in another HDD.

These loop image recording, storage image recording, and mirror image recording, as described above, are started up by solely depressing the loop image recording switch 101, the storage image recording switch 102, and the mirror image recording switch 103 of the remote controller R while broadcast contents are viewed by means of a tuner of a digital television (or hard disk recorder and the like).

However, in another case in which a current operation is moved to a storage image recording halfway by depressing the storage image recording switch 102 while in loop image recording, the mirror image recording switch 103 may be depressed while in loop image recording similarly, making it possible to move the current operation to a mirror image recording halfway.

Furthermore, in particular, in the case where the broadcast recording apparatus is a hard disk recorder (or digital television with reservation image recording function), it is preferable to set whether to carry out normal storage image recording or reservation image recording by mirror image recording on an image recording reservation screen of a reservation image recording unit 43. In addition, when a set time has come, it is preferable to reserve or record normal storage image recording or mirror image recording for a plurality of hard disk drives.

Furthermore, in the case where the broadcast recording apparatus is a hard disk recorder (or digital television with reservation image recording function), on a display screen on which reproducible broadcast contents are selectively displayed after terminating reservation image recording, it is preferable to selectively carry out mirror image recording on a broadcast content by content basis by specifying these broadcast contents as targets by means of a cursor or the like, and then, depressing the mirror image recording switch 103. The video image voice signal recorded in a single hard disk drive is subjected to mirror image recording in another hard disk drive by means of a mirror image recording setting operation, thereby making it possible to reliably store the signal again in a reproducible manner even if a hard disk failure occurs.

Furthermore, in the case where the broadcast recording apparatus is a hard disk recorder (or digital television with reservation image recording function), even if there is provided an auto reservation function of carrying out image recording and reservation by entering a keyword such as “soccer” and automatically making a search for a soccer program, without carrying out a user's specific reservation processing operation, the use of a plurality of HDDs is preferred.

That is, in reservation image recording using the reservation image recording unit 43 having such an auto reservation function, the video image and voice signals acquired by the auto reservation function are specified by means of an operating signal responsive to an operation of the first hard disk drive 61, a user's normal operation of the remote controller R or the like shown in FIG. 1. With respect to the video image and voice signals responsive to a reservation program, it is preferable to specify an image recording reservation destination as in the second hard disk drive 62 and the like. In this manner, the content information of a plurality of hard disk drives can be managed very easily. In addition, a method of carrying out the above-described mirror image recording (image recording in a plurality of hard disk drives) is preferred in that program contents of the auto reservation function are recorded as an image in one hard disk drive, and then, the program contents reserved and recorded as an image by operation are reliably recorded as an image.

One skilled in the art can achieve the present embodiment by a variety of embodiments described above. Further, a variety of modified examples of these embodiments can be readily conceived by one skilled in the art. It is possible to apply them to a variety of embodiments even if one does not have any inventive ability. Therefore, the present invention covers a broad scope without departing from disclosed principles and novel features, and is limited to the above-described embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recording apparatus, comprising:
a tuner unit which receives a broadcast signal, demodulates the received signal, and outputs video image and voice signals;
first and second hard disk drive units which record the video image and voice signals from the tuner unit in a memory region; and
a control unit which controls the first and second hard disk drive units to record the video image and voice signals in each one of a first storage memory region of the first hard disk drive unit and a second storage memory region of the second hard disk drive unit.

2. The broadcast recording apparatus according to claim 1, further comprising a display which displays a video image in response to the video image and voice signals.

3. The broadcast recording apparatus according to claim 1, wherein the control unit records the video image and voice signals within a range of a time limit in at least one loop memory region of the first hard disk drive unit or the second hard disk drive unit, and carries out loop image recording for making overwrite recording in a memory region in which recording has been already made if the time limit is exceeded.

4. The broadcast recording apparatus according to claim 3, wherein the control unit distributes the video image and voice signals in a first loop memory region of the first hard disk drive unit and a second loop memory region of the second hard disk drive unit, and then, controls the distributed signals to carry out the loop image recording.

5. The broadcast recording apparatus according to claim 3, wherein the control unit further controls the loop image-recorded video image and voice signals in the loop memory region to be further recorded in each one of the first storage memory region of the first hard disk drive unit and the second storage memory region of the second hard disk drive unit.

6. The broadcast recording apparatus according to claim 3, wherein the storage memory region and the loop memory region in the first and second hard disk drive units are divided by means of a partition.

7. The broadcast recording apparatus according to claim 1, further comprising a reservation image recording unit which has an auto reservation function of automatically determining a reservation program in accordance with predetermined information and which carries out reservation image recording of the broadcast signal by using the tuner unit based on a reservation program determined by the auto reservation function and a reservation program specified by an operating signal,
wherein the control unit controls the reservation image recording unit to record video image and voice signals according to a reservation program determined by the auto reservation function in the first hard disk drive unit and video image and voice signals according to a reservation program specified by the operating signal in the second hard disk drive unit.

8. The broadcast recording apparatus according to claim 1, further comprising a third hard disk drive unit which records the video image and voice signals in a memory region,
wherein the control unit carries out recording of the video image and voice signals for the first to third hard disk drive units.

9. The broadcast recording apparatus according to claim 8, wherein the control unit generates parity data of the data recorded in the first to third hard disk drive units, and then, records these items of data to be divided into the first to third hard disk drive units.

10. The broadcast recording apparatus according to claim 1, wherein the control unit detects a signal produced by depressing a switch of a remote controller, thereby recording the video image and voice signals in each one of the first storage memory region of the first hard disk drive unit and the second storage memory region of the second hard disk drive unit.

11. The broadcast recording apparatus according to claim 1, wherein the control unit, upon detection of a signal produced by depressing a first switch of a remote controller, records the video image and voice signals within a range of a time limit in at least one loop memory region of the first hard disk drive unit or the second hard disk drive unit, and then, carries out loop image recording for making overwrite recording in the loop memory region in which recording has been made if the time limit is exceeded;
when a signal produced by depressing a second switch of the remote controller is detected, the control unit records the video image and voice signals in at least one of the first storage memory region of the first hard disk drive unit and the second storage memory region of the second hard disk drive unit; and
when a signal produced by depressing a third switch of the remote controller is detected, the control unit records the video image and voice signals in each one of the first storage memory region of the first hard disk drive unit and the second storage memory region of the second hard disk drive unit.

12. The broadcast recording apparatus according to claim 1, wherein the hard disk drive unit has an interface unit and is removable.

13. A broadcast recording method, comprising:
receiving and demodulating a broadcast signal, and then, outputting video image and voice signals; and
recording the video image and voice signals in each one of a first storage memory region of a first hard disk drive unit and a second storage memory region of a second hard disk drive unit.

14. The broadcast recording method according to claim 13, wherein the video image and voice signals are recorded within a range of a time limit in at least one loop memory region of the first hard disk drive unit or the second hard disk drive unit, and loop image recording for making overwrite recording in a memory region in which recording has been already made is carried out if the time limit is exceeded.

15. The broadcast recording method according to claim 14, wherein the video image and voice signals are distributed in a first loop memory region of the first hard disk drive unit and a second loop memory region of the second hard disk drive unit, and then, the distributed signals are controlled to carry out the loop image recording.

16. The broadcast recording method according to claim 15, wherein the loop image-recorded video image and voice signals in the loop memory region are further controlled to be recorded in each one of the first storage memory region of the first hard disk drive unit and the second storage memory region of the second hard disk drive unit.

17. The broadcast recording method according to claim 13, wherein recording of the video image and voice signals are carried out in a third hard disk drive unit as well as the first and second hard disk drive units.
